(19) United States
(12) Patent Application Publication
(10) Pub. No.: US 2026/0313366 A1
(43) Pub. Date: Oct. 8, 2026

(54) METHOD AND APPARATUS FOR HANDLING A PERSONAL INTERNET OF THINGS

(71) Applicant: SAMSUNG ELECTRONICS CO., LTD., Gyeonggi-do (KR)

(72) Inventors: Aman AGARWAL, Bangalore (IN); Lalith KUMAR, Bangalore (IN); Sidhant JAIN, Bangalore (IN); Arunprasath RAMAMOORTHY, Bangalore (IN)

(21) Appl. No.: 19/485,090

(22) PCT Filed: May 14, 2024
(86) PCT No.: PCT/KR2024/006526

§ 371 Date: Nov. 17, 2025

(30) Foreign Application Priority Data
May 16, 2023 (IN) 202341034400
Apr. 30, 2024 (IN) 202341034400

(51) Int. Cl. H04W 12/00; H04W 4/70; H04W 12/71; H04W 12/72; H04W 60/06

(52) U.S. Cl. CPC H04W 12/009; H04W 4/70; H04W 12/71; H04W 12/72; H04W 60/06

(57) ABSTRACT

The disclosure relates to a 5G or 6G communication system for supporting a higher data transmission rate. A method performed by a personal internet of things (IoT) network element (PINE) in a wireless communication system, the method comprising: transmitting, to a PIN server, a request for a de-registration, the request including a security credential of the PINE received during authorization procedure with the PIN server; and receiving, from the PIN server, a response for the de-registration, the response including a status of the request for the de-registration.

### TECHNICAL FIELD

The embodiments disclosed herein generally relate to the field of network, and more particularly, to a Personal IoT Network (PIN) Element Context and Validity/Lifetime Handling.

### BACKGROUND ART

Wireless communication has been one of the most successful innovations in modern history. Recently, the number of subscribers to wireless communication services exceeded five billion and continues to grow quickly. The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage are of paramount importance. To meet the demand for wireless data traffic having increased since deployment of 4G communication systems, and to enable various vertical applications, 5G communication systems have been developed and are currently being deployed.

5th generation (5G) or new radio (NR) mobile communications is recently gathering increased momentum with all the worldwide technical activities on the various candidate technologies from industry and academia. The candidate enablers for the 5G/NR mobile communications include massive antenna technologies, from legacy cellular frequency bands up to high frequencies, to provide beamforming gain and support increased capacity, new waveform (e.g., a new radio access technology (RAT)) to flexibly accommodate various services/applications with different requirements, new multiple access schemes to support massive connections, and so on.

5G mobile communication technologies define broad frequency bands such that high transmission rates and new services are possible, and can be implemented not only in “Sub 6 GHz” bands such as 3.5 GHZ, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

### DISCLOSURE OF INVENTION

### Technical Problem

The principal object of the embodiments herein is to provide a method for handling Personal IoT Network (PIN) element (PINE) context and validity of a PIN element.

Another object of the embodiments herein is to handle a de-registration procedure.

Another object of the embodiments herein is to handle an update-registration procedure.

### Solution to Problem

A method performed by a personal internet of things (IoT) network element (PINE) in a wireless communication system, the method comprising: transmitting, to a PIN server, a request for a de-registration, the request including a security credential of the PINE received during authorization procedure with the PIN server; and receiving, from the PIN server, a response for the de-registration, the response including a status of the request for the de-registration.

A method performed by a personal internet of things (IoT) network (PIN) server in a wireless communication system, the method comprising: receiving, from a PIN element (PINE), a request for a de-registration, the request including a security credential of the PINE received during authorization procedure with the PIN server; and transmitting, to the PINE, a response for the de-registration, the response including a status of the request for the de-registration.

A personal internet of things (IoT) network element (PINE) in a wireless communication system, the PINE comprising: a transceiver; and a controller coupled with the transceiver and configured to: transmit, to a PIN server, a request for a de-registration, the request including a security credential of the PINE received during authorization procedure with the PIN server, receive, from the PIN server, a response for the de-registration, the response including a status of the request for the de-registration.

A personal internet of things (IoT) network (PIN) server in a wireless communication system, the PINE comprising: a transceiver; and a controller coupled with the transceiver and configured to: receive, from a PIN element (PINE), a request for a de-registration, the request including a security credential of the PINE received during authorization procedure with the PIN server; and transmit, to the PINE, a response for the de-registration, the response including a status of the request for the de-registration.

### BRIEF DESCRIPTION OF DRAWINGS

This invention is illustrated in the accompanying drawings, throughout which like reference letters indicate corresponding parts in the various figures. The embodiments herein will be better understood from the following description with reference to the drawings, in which:

FIG. 1 is sequence diagram illustrating a PINE/PEGC/PEMC gets disconnected/de-registered/deleted/loses authorization/released from PIN or PIN Server or 5GC/5GS, according to a prior art;

FIG. 2 is a sequence diagram illustrating a 5GC and the PIN Server remove a PINE information from a context, according to the embodiments disclosed herein;

FIG. 3 is a sequence diagram illustrating the 5GC and the PIN Server remove the PINE information from the context when a PINE context timer is expired, according to the embodiments disclosed herein;

FIG. 4 is a sequence diagram illustrating the 5GC/5GS are stop the PINE context timer when a 5GC periodic update timer is expired, according to the embodiments disclosed herein;

FIG. 5 is a sequence diagram illustrating the PIN Server starts a PIN Element Context Periodic Update timer and periodically receive periodic updates from the 5GS/5GC about the PINE/PEGC/PEMC, according to the embodiments disclosed herein;

FIG. 6 is a sequence diagram illustrating a PINE sending de-registration request to PIN Server. PIN server then indicates to 5GS/5GC to remove the PINE information from a context, according to the embodiments disclosed herein;

FIG. 7 is a sequence diagram illustration the PINE sending a PINE De-registration request to PIN Server directly, according to the embodiments disclosed herein;

FIG. 8 is a sequence diagram illustration the PINE sending a PINE De-registration request to PIN Server indirectly via PEMC, according to the embodiments disclosed herein;

FIG. 9 is a sequence diagram illustration the PINE sending a PINE De-registration request to PIN Server indirectly via PEMC along with the PIN Leave Request, according to the embodiments disclosed herein;

FIG. 10 is a sequence diagram illustration the PINE sending a PINE update registration request to PIN Server directly, according to the embodiments disclosed herein;

FIG. 11 shows various hardware components of the PINE, according to the embodiments as disclosed herein;

FIG. 12 shows various hardware components of the PIN server, according to the embodiments as disclosed herein;

FIG. 13 is a flow chart illustrating method, implemented by the PINE, for handling PINE context and validity of a PIN element based on a PINE de-registration request, according to the embodiments as disclosed herein;

FIG. 14 is a flow chart illustrating method, implemented by the PINE, for handling PINE context and validity of a PIN element based on a PINE update registration request, according to the embodiments as disclosed herein;

FIG. 15 is a flow chart illustrating method, implemented by the PIN server, for handling PINE context and validity of a PIN element based on the PINE de-registration request, according to the embodiments as disclosed herein; and

FIG. 16 is a flow chart illustrating method, implemented by the PIN server, for handling PINE context and validity of a PIN element based on a PINE update registration request, according to the embodiments as disclosed herein.

It may be noted that to the extent possible, like reference numerals have been used to represent like elements in the drawing. Further, those of ordinary skill in the art will appreciate that elements in the drawing are illustrated for simplicity and may not have been necessarily drawn to scale. For example, the dimension of some of the elements in the drawing may be exaggerated relative to other elements to help to improve the understanding of aspects of the invention. Furthermore, the one or more elements may have been represented in the drawing by conventional symbols, and the drawings may show only those specific details that are pertinent to the understanding the embodiments of the invention so as not to obscure the drawing with details that will be readily apparent to those of ordinary skill in the art having benefit of the description herein.

### MODE FOR THE INVENTION

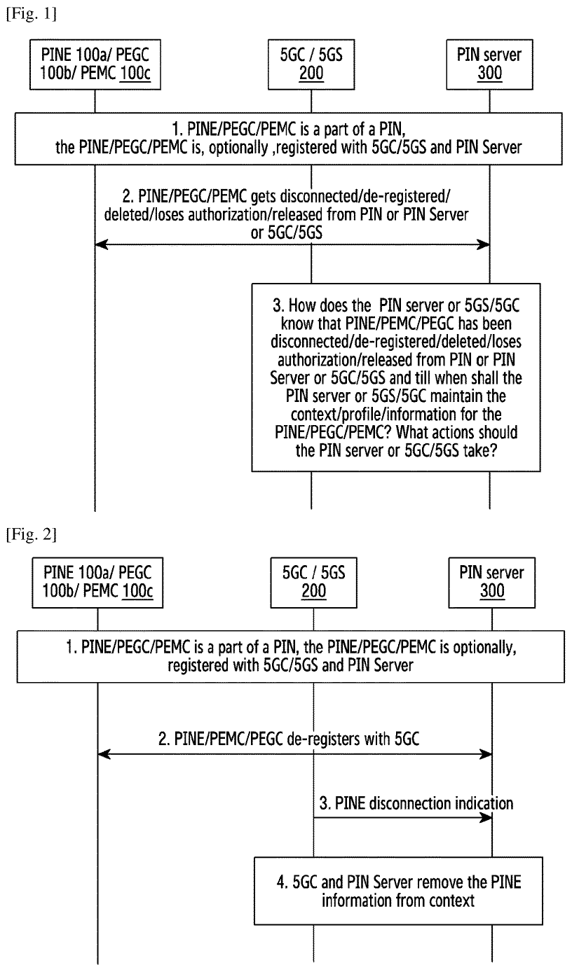

FIG. 1 is sequence diagram illustrating a PINE (100A)/PEGC (100B)/PEMC (100C) gets disconnected/de-registered/deleted/loses authorization/released from PIN or PIN server (300) or 5GC/5GS (200), according to a prior art.

The PINE (100A) or a PEMC (100C) or a PEGC (100B) can be part of multiple PINs. The PINE (100A)/PEGC (100B)/PEMC (100C) may register with the PIN server (300) via the PEGC (100B) or may register directly. The PIN server (300) maintains a PIN profile or a PIN Client profile and the PINE (100A) profile with it for the PIN and PINE (100A)/PEGC (100B)/PEMC (100C) and optionally also maintain a PINE (100A)/PEGC (100B)/PEMC context in the PIN server (300).

The PINE (100A) which are part of the PIN, may optionally get authorized/registered to access 5G (5GC or 5GS) by the PIN server (300) or 5GC/5GS (200) and register/authorize with 5GC/5GS (200) to get 5GC/5GS (200) services.

In a first scenario, at step 1-At step 3, when the PINE (100A) or PEMC (100C) or PEGC (100B), which is registered with 5GC/5GS (200), gets de-registered/loses authorization that is no more authorized to access the 5GS/5GC or the PIN server (300) from the 5GC/5GS (200), what should be the behaviour for that PINE (100A)/PEGC (100B)/PEMC (100C) at the PIN server (300) is not defined in the current conventional systems and needs to be handled.

In a second scenario, when the PINE (100A) or PEMC (100C) or PEMC (100C) gets disconnected/de-registered/deleted/loses authorization/released from the PIN or PIN server (300), how does the 5GC/5GS (200) know about PINE (100A)/PEMC (100C)/PEGC (100B) disconnection/de-registration/deletion/release/de-authorization is not defined in the conventional system and needs to be handled.

In a third scenario, currently, there is no sync maintained between the 5GC/5GS (200) and the PIN server (300) regarding the context of PINE (100A)/PEGC (100B)/PEMC (100C) during any of the PIN related procedures (for example, PINE (100A)/PEMC (100C)/PEGC (100B) disconnection/de-registration/deletion/release/de-authori zation). When/How does the PIN server (300) and/or 5GC/5GS (200) remove the PINE (100A)/PEGC (100B)/PEMC (100C) information from the PINE (100A)/UE/PIN context or from the PIN Profile or from the PIN client profile/information/context is not defined in the conventional system and needs to be handled.

In a fourth scenario, when the PINE (100A)/PEMC (100C)/PEGC (100B) which may be a part of multiple PINs and are optionally registered with same PIN server (300), leave/gets deleted/de-registered/released/disconnected/de-authorized from any one of the PIN, what actions should the PIN server (300) or the 5GC/5GS (200) take for that PINE (100A)/PEGC (100B)/PEMC (100C) is not defined in the conventional system and needs to be handled.

The above information is presented as background information only to help the reader to understand the present invention. Applicants have made no determination and make no assertion as to whether any of the above might be applicable as prior art with regard to the present application.

Embodiments disclosed herein provide a method for handling Personal IoT Network (PIN) element (PINE) context and validity of a PIN element. The method includes sending, by a PINE, a PINE de-registration request to a PIN server. The PINE de-registration request includes a security credential and information. Further, the method includes receiving, by the PINE, a PINE de-registration response with a status of the PINE de-registration request from the PIN server based on the PINE de-registration request. The PINE de-registration response indicates at least one of: the PINE is successfully de-registered, and the PINE is not successfully de-registered. The PINE de-registration response indicates a failure response with cause of de-registration failure from the PIN server, when the PINE de-registration response indicates the PINE is not successfully de-registered.

In an embodiment, the PINE sends the PINE de-registration request to the PIN server directly or via at least one of: a PIN Element with Management Capability (PEMC) and PIN Element with Gateway Capability (PEGC).

In an embodiment, the PINE receives the PINE de-registration response with the status of the PINE de-registration request from the PIN server directly or via at least one of: a PEMC and a PEGC.

In an embodiment, the PINE includes at least one of: a User Equipment (UE) that communicates within a PIN, a non-3GPP device that communicates within a PIN, a PEMC and a PEGC.

In an embodiment, the information includes at least one of: a Generic Public Subscription Identifier (GPSI), a Medium Access Control (MAC) address, vendor name, a device description, a PIN element identifier (ID), a PIN client ID and a PINE address.

Embodiments disclosed herein provide a method for handling PINE context and validity of a PIN element. The method includes receiving, by a PIN server, a PINE de-registration request from at least one of a PINE, a PEMC and a PEGC entity. The PINE de-registration request includes a security credential and information. Further, the method includes validating, by the PIN server, the PINE based on the PINE de-registration request. Further, the method includes determining, by the PIN server, that the PINE has an active registration with the PIN server. Further, the method includes sending, by the PIN server, a PINE de-registration response with a status of the PINE de-registration request to the PINE based on the determination. The PINE de-registration response indicates at least one of: the PINE is successfully de-registered, and the PINE is not successfully de-registered. Further, the method includes sending, by the PIN server, a PINE de-registration response with a failure response with cause of de-registration failure to the PINE, when the PINE de-registration response indicates the PINE is not successfully de-registered. Further, the method includes deleting, by the PIN server, all configuration for the PINE, when the PINE de-registration response indicates the PINE is successfully de-registered.

Embodiments disclosed herein provide a method for handling PINE context and validity of the PIN element. The method includes sending, by a PINE, a PINE update registration request to a PIN server. The PINE update registration request includes a security credential and information. Further, the method includes receiving, by the PINE, a PINE update registration response with a status of the PINE update registration request from the PIN server based on the PINE update registration request. The PINE update registration response indicates at least one of: the PINE update registration request is successful and the PINE update registration request is failed.

In an embodiment, the PIN server provides a failure response with cause of update registration failure to the PINE, when the PINE update registration request is failed.

In an embodiment, the PINE sends the PINE update registration request to the PIN server directly or via at least one of: a PEMC and a PEGC.

In an embodiment, the PINE receives the PINE update registration response with the status of the PINE update registration request from the PIN server directly or via at least one of: a PEMC and a PEGC.

Embodiments disclosed herein provide a method for handling PINE context and validity of the PIN element. The method includes receiving, by a PIN server, a PINE update registration request from a PINE. The PINE update registration request includes a security credential and information. Further, the method includes validating, by the PIN server, the PINE based on the PINE update registration request. Further, the method includes determining, by the PIN server, that the PINE has an active registration with the PIN server. Further, the method includes sending, by the PIN server, a PINE update registration response with a status of the PINE update registration request to the PINE based on the determination. The PINE update registration response indicates at least one of: the PINE update registration request is successful and the PINE update registration request is failed.

Embodiments disclosed herein provide a PINE for handling a PINE context and validity of the PIN element. The PINE includes a PINE context and validity controller communicatively coupled to a memory and a processor. The PINE context and validity controller is configured to send a PINE de-registration request to a PIN server. The PINE de-registration request includes a security credential and information. Further, the PINE context and validity controller is configured to receive a PINE de-registration response with a status of the PINE de-registration request from the PIN server based on the PINE de-registration request. The PINE de-registration response indicates at least one of: the PINE is successfully de-registered, and the PINE is not successfully de-registered. Further, the PINE context and validity controller is configured to receive a PINE de-registration response with a failure response with cause of de-registration failure from the PIN server, when the PINE de-registration response indicates the PINE is not successfully de-registered.

Embodiments disclosed herein provide a PINE for handling a PINE context and validity of the PIN element. The PINE includes a PINE context and validity controller communicatively coupled to a memory and a processor. The PINE context and validity controller is configured to send a PINE update registration request to a PIN server. The PINE update registration request includes a security credential and information. The PINE context and validity controller is configured to receive a PINE update registration response with a status of the PINE update registration request from the PIN server based on the PINE update registration request. The PINE update registration response indicates at least one of: the PINE update registration request is successful and the PINE update registration request is failed.

Embodiments disclosed herein provide a PIN server for handling PINE context and validity of the PIN element. The PIN server includes a PINE context and validity controller communicatively coupled to a memory and a processor. The PINE context and validity controller is configured to receive a PINE de-registration request from at least one of a PINE, a PEMC and a PEGC. The PINE de-registration request includes a security credential and information. The PINE context and validity controller is configured to validate the PINE based on the PINE de-registration request. The PINE context and validity controller is configured to determine that the PINE has an active registration with the PIN server. The PINE context and validity controller is configured to send a PINE de-registration response with a status of the PINE de-registration request to the PINE based on the determination. The PINE de-registration response indicates at least one of: the PINE is successfully de-registered, and the PINE is not successfully de-registered. Further, the PINE context and validity controller is configured to send a PINE de-registration response with a failure response with cause of de-registration failure to the PINE, when the PINE de-registration response indicates the PINE is not successfully de-registered. Further, the PINE context and validity controller is configured to delete all configuration for the PINE, when the PINE de-registration response indicates the PINE is successfully de-registered

Embodiments disclosed herein provide a PIN server for handling PINE context and validity of the PIN element. The PIN server includes a PINE context and validity controller communicatively coupled to a memory and a processor. The PINE context and validity controller is configured to receive a PINE update registration request from a PINE. The PINE update registration request includes a security credential and information. The PINE context and validity controller is configured to validate the PINE based on the PINE update registration request. The PINE context and validity controller is configured to determine that the PINE has an active registration with the PIN server. The PINE context and validity controller is configured to send a PINE update registration response with a status of the PINE update registration request to the PINE based on the determination. The PINE update registration response indicates at least one of: the PINE update registration request is successful and the PINE update registration request is failed.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the scope thereof, and the embodiments herein include all such modifications.

Various embodiments of the present disclosure will now be described in detail with reference to the accompanying drawings. In the following description, specific details such as detailed configuration and components are merely provided to assist the overall understanding of these embodiments of the present disclosure. Therefore, it should be apparent to those skilled in the art that various changes and modifications of the embodiments described herein can be made without departing from the scope of the present disclosure. In addition, descriptions of well-known functions and constructions are omitted for clarity and conciseness.

Also, the various embodiments described herein are not necessarily mutually exclusive, as some embodiments can be combined with one or more other embodiments to form new embodiments.

Herein, the term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and may optionally be driven by firmware and software. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents and substitutes in addition to those which are particularly set out in the accompanying drawings. Although the terms first, second, etc. may be used herein to describe various elements, these elements should not be limited by these terms. These terms are generally only used to distinguish one element from another.

Embodiments disclosed herein provide a method for handling PINE context and validity of a PIN element. The method includes sending, by a PINE, a PINE de-registration request to a PIN server. The PINE de-registration request includes a security credential and information. Further, the method includes receiving, by the PINE, a PINE de-registration response with a status of the PINE de-registration request from the PIN server based on the PINE de-registration request. The PINE de-registration response indicates at least one of: the PIN server deletes all configuration for the PINE when the PINE is successfully de-registered, and the PIN server gives failure response with cause of de-registration failure to the PINE, when the PINE is not successfully de-registered.

In general, Fifth Generation system (5GS) supports Personal IoT Network (PIN). The methods, issues or solutions disclosed in an embodiment are explained using a PIN server or 5GS or 5G core (5GC) as an example and is not restricted or limited to PIN server or 5GS or 5GC only. However, the solutions proposed in this embodiment are also applicable for any PIN management procedures or 5GC/5GS management procedure. However, the solutions proposed in this embodiment are also applicable for Evolved Universal Mobile Telecommunication Access Network (E-UTRAN) access Technology, NB (Narrow Band)-S1 mode or WB (Wide Band)-S1 mode via E-UTRAN access and/or NB-IoT (NarrowBand Internet Of Things) or WB-IoT (WideBand Internet Of Things) Access/Architecture.

The solutions which are defined for NR (5GC) are also applicable to legacy Radio Access Technology (RAT) like E-UTRA/LTE, the corresponding CN entities needs to be replaced by Long Term Evolution (LTE) entities for e.g. Access and Mobility Management Function (AMF) with Mobility Management Entity (MME), Next generation Node-B (gnodeB) with evolved-nodeB (e-nodeB), UDM with HSS etc. But principles of the solution remains same. An example list of NAS messages can be, but not limited to, REGISTRATION REQUEST message; DEREGISTRATION REQUEST message; SERVICE REQUEST message; CONTROL PLANE SERVICE REQUEST; IDENTITY REQUEST; AUTHENTICATION REQUEST; AUTHENTICATION RESULT; AUTHENTICATION REJECT; REGISTRATION REJECT; DEREGISTRATION ACCEPT; SERVICE REJECT; SERVICE ACCEPT, and so on.

A Network (NW) used in the embodiment is explained using any 5G Core Network Function for e.g. AMF. However, the network could be any 5G/EUTRAN Core Network Entities like AMF/SMF/MME/UPF or the Network could be any 5G/EUTRAN RAN Entity like eNodeB (eNB) or gNodeB (gNB) or NG-RAN etc. The messages used or indicated in the embodiment are shown as an example. The messages could be any signalling messages between a UE and the Network Functions/Entities or between different Network functions/entities. The term area/location/geographical area are used in this embodiment may refer to any of cell/cell ID, Tracking Area Code (TAC)/Tracking Area Identity (TAI), Public Land Mobile Network (PLMN), Mobile Country Code (MCC)/Mobile Network Code (MNC), Latitude/longitude, CAG cell or any geographical location/coordinate.

The terms camp and register are used interchangeably and have the same meaning. The terms PINE, PIN Element and PIN-E are used interchangeably and have the same meaning. The procedures and solutions defined in this embodiment can apply to any of the PINE or PEGC or PEMC or any PIN Element or Entity. The examples explained in this embodiment are just used as an illustration. The terms PIN profile, PIN context, PIN information are used interchangeably and have the same meaning. The terms PINE profile, PINE context, PINE information, PIN Client Profile, PIN client information, PIN client context are used interchangeably and have the same meaning. The terms Validity or lifetime or duration are used interchangeably and have the same meaning. The terms 5GC and 5GS are used interchangeably and have the same meaning.

For the list of possible NAS messages please refer to 3GPP TS 24.501 or 3GPP TS 24.301, for list of AS messages please refer to 3GPP TS 38.331 or 3GPP TS 36.331. The cause names in this embodiment are for illustration purpose and it can have any name. The non-access stratum (NAS) messages and access stratum (AS) messages described in this embodiment is only for illustration purpose it can be any NAS or AS messages as per defined protocol between UE and AMF/MME or UE and gNB (NG-RAN/any RAN node)/eNB.

Embodiments disclosed herein provide a PIN element context and validity/lifetime handling. A PINE/PEMC/PEGC is a part of a PIN and optionally registered with a 5GC/5GS and a PIN server serving that the PIN. When the PINE/PEGC/PEMC gets disconnected/de-registered/deleted/loses authorization/released from the PIN or PIN Server or if the complete PIN is deleted, PIN profile or PIN Client profile is updated/removed at PIN server accordingly. The PIN server informs/indicates to the 5GC/5GS via any indication or message or any signalling that the PINE/PEGC/PEMC has been disconnected/de-registered/deleted/loses authorization/released from the PIN or PIN Server, and 5GC/5GS (e.g. AMF) updates the PINE/PEGC/PEMC (UE) context with this information and may even delete the PINE/PEGC/PEMC (UE) context. Alternatively, the PEGC/PEMC or the PINE itself informs the 5GC/5GS about leaving/disconnected/de-registered/deleted/loses authorization/released from the PIN or the PIN Server, this indication can be sent directly by PEMC/PEGC or PINE or indirectly via PEGC/PEMC. The PINE may, Deregister with 5GC (due to local reasons such as subscription over/expired or scheduled maintenance or scheduled Switch Off etc. or based on indication from PIN SERVER or 5GS) directly or via PEMC/PEGC. The PINE leaving, deregistering the PIN may or may not include PIN IDs in the indication. The events such as leaving/disconnected/de-registered/delet ed/loses authorization/released from the PIN/PIN Server is just shown as an example and it could be any event triggered by the PINE/PEMC/PEGC or by the PIN Server (such as Join/Delete/Create etc.). The PINE/PEGC/PEMC may send deregistration request directly or via PEGC/PEMC to all the PIN servers which are handling the PINs which the said PINE is part of, when it gets disconnected/de-registered/deleted/loses authorization/released from 5GC or PIN server.

In another embodiment, the PINE may include de-registration request in the PIN leave request itself. The PEMC on receiving the PIN leave request may determine if the PINE needs to be de-registered as well. If the PINE has included a PINE de-registration request in the PIN leave request, the PEMC shall remove the PINE from the PIN and send the PINE de-registration request to the PIN server. The PIN server on receiving PINE de-registration request from PINE directly or via PEGC/PEMC, deregisters the PINE and indicates to 5GC/other PINs (PEGC/PEMC) including the same PINE, other PIN servers serving the PINs which have the said PINE as member. The PINE may send de-registration request to PIN server with PIN leave request or before or after sending the PIN leave request.

In another embodiment, the PEMC/PEGC handle the de-registration request received from PINE and forward the request to PIN server/5GC accordingly. The PEGC/PEMC must remove the PINE from all the PINs when it receives de-registration indication for that PINE from the any of the PIN servers or 5GC. The PEGC/PEMC shall include PIN IDs for PINs from which it wants to leave in the de-registration/leave request sent to the PIN server, if the PEGC/PEMC was acting as primary PEMC or optionally secondary PEMC or default PEGC or optionally backup PEGC so that the PIN server can assign other PEGC/PEMC as primary/secondary PEMC or default/backup PEGC for that PIN.

In yet another embodiment, the PEGC/PEMC may or may not include PIN IDs for PINs from which it wants to leave in the de-registration/leave request sent to the PIN server, if the PEGC/PEMC was acting as primary PEMC or optionally secondary PEMC or default PEGC or optionally backup PEGC so that the PIN server can assign other PEGC/PEMC as primary/secondary PEMC or default/backup PEGC for that PIN.

In yet another embodiment, the PEGC/PEMC may or may not include PIN IDs for PINs from which it wants to leave in the de-registration/leave request sent to the PIN server so that the PIN server can assign other PEGC/PEMC for that PIN.

In yet another embodiment, the PIN server itself determines the PINs for which the requesting PEGC/PEMC was acting as PEGC (default PEGC or backup PEGC) or PEMC (either primary or secondary PEMC) for, and starts procedure to assign new PEGC/PEMC for the respective PINs.

In yet another embodiment, the 5GC/5GS (e.g. AMF) updates the PINE/PEGC/PEMC (UE) context/profile/information based on any event or trigger from the PIN Server or PINE/PEGC/PEMC (events such as, but not limited to, PINE/PEGC/PEMC Join/Delete/Leave/Register with/to the PIN or PIN server or such as PIN create/delete etc. or PINE subscription expiry at 5GC).

In yet another embodiment, the PIN server indicates to all PINs (PEGC/PEMC), served by this PIN Server and for which the PINE is part of, to remove the PINE from the PINs, when the PINE directly deregisters from the PIN Server, or such deregistration results from any indication from 5GC/PEMC/PEGC. If there is any signalling or procedure (For example: PINE management procedures like PIN Join/PIN Leave or any service is requested) or request generated from this PINE towards the PIN or PEGC/PEMC or other PINEs, then the signalling or procedure or request or requested service shall be rejected with appropriate reject cause to indicate that the PINE is already de-registered and not a part of/not available in this Pin anymore. The PIN server may indicate to other PIN servers serving any PIN which has the PINE about deregistration of PINE, so the other PIN servers may deregister the PINE from them.

In yet another embodiment, the other PIN server (e.g.—second PIN server and third PIN server) may still keep the PINE registered even if the PINE is deregistered from a PIN Server (e.g. first PIN Server)

In yet another embodiment, the 5GC/5GS (e.g. AMF) deletes the PINE/PEGC/PEMC (UE) context/profile/information based on any event (such as Subscription is expired at 5GC) or trigger from the PIN Server or PINE/PEGC/PEMC (events such as, but not limited to, PINE/PEGC/PEMC Join/Delete/Leave/Register with/to the PIN or PIN server or such as PIN create/delete etc.) if the PINE/PEGC/PEMC is not a part of any of the PIN anymore. Optionally, the 5GC/5GS may start a timer (such as PINE/PEGC/PEMC context delete wait timer) and wait for the timer to expire before deleting the PINE/PEGC/PEMC (UE) context/profile/information. If the PINE/PEGC/PEMC joins/registers/becomes a part of a PIN/PIN Server before the timer expires, the timer would be stopped and PINE/PEGC/PEMC (UE) context/profile/information would not be deleted and would still be maintained at 5GC/5GS.

In yet another embodiment, the 5GC/5GS (e.g. AMF) maintains a validity or duration or lifetime of the PINE/PEGC/PEMC (UE) context/profile/information, which may be optionally different from the 5GC/5GS context of that PINE/PEGC/PEMC (UE). If the validity or duration or lifetime of the PINE/PEGC/PEMC (UE) context/profile/information expires, the 5GC/5GS (e.g. AMF) deletes the PINE/PEGC/PEMC (UE) context/profile/information. The timer related to the validity or duration or lifetime of the PINE/PEGC/PEMC (UE) context/profile/information is started/re-started/refreshed/reset when the PINE/PEGC/PEMC (UE) context/profile/information is first stored or optionally updated at the 5GC/5GS, during any of events (for example, during registration/authorization of PINE/PEGC/PEMC with the PIN Server or during any PINE/PEGC/PEMC joins/registers/becomes a part of a PIN/PIN Server etc. or due to any indication/signalling/message from the PIN server/PINE/PEMC/PEGC to update/store the context or reset/refresh/restart the timer).

Below are the abbreviations used in the specification—
1) 3GPP Third Generation Partnership Project
2) 4G-GUTI 4G-Globally Unique Temporary Identifier
3) 5G-BRG 5G Broadband Residential Gateway
4) 5GC 5G Core
5) 5GCN 5G Core Network
6) 5G-CRG 5G Cable Residential Gateway
7) 5G-GUTI 5G-Globally Unique Temporary Identifier
8) 5GMM 5G Mobility Management
9) 5G-RG 5G Residential Gateway
10) 5GS 5G System
11) 5GSM 5GS Session Management
12) 5G-S-TMSI 5G S-Temporary Mobile Subscription Identifier
13) 5G-TMSI 5G Temporary Mobile Subscription Identifier
14) 5QI 5G QoS Identifier
15) ACS Auto-Configuration Server
16) AMF Access and Mobility Management Function
17) APN Access Point Name
18) AS Access Stratum
19) A-TID AKMA Temporary Identifier
20) ATSSS Access Traffic Steering, Switching and Splitting
21) AUSF Authentication Server Function
22) CU Centralized Unit
23) DC Discontinuous Coverage
24) DisCo Discontinuous Coverage
25) DL Downlink
26) DRX Discontinuous Reception
27) DU Distributed Unit
28) eDRX Extended Discontinuous Reception
29) EHPLMN Equivalent Home Public Land Mobile Network
30) EMM EUTRA Mobility Management
31) eNB Evolved Node-B
32) EPC Evolved Packet Core
33) EPLMN Equivalent Public Land Mobile Network
34) EPS Evolved Packet System
35) E-UTRA Evolved Universal Mobile Telecommunication Access
36) EUTRAN Evolved Universal Mobile Telecommunication Access Network
37) FPLMN Forbidden Public Land Mobile Network
38) FR Frequency Range
39) GEO Geostationary Orbit
40) gNB Next generation Node-B
41) gNB-CU Next generation Node-B Control Unit
42) gNB-DU Next generation Node-B Distributive Unit
43) GPRS General Packet Radio Service
44) GPS Global Positioning System
45) GSM Global System for Mobile Communication
46) HPLMN Home Public Land Mobile Network
47) IE Information Element
48) LADN Local Area Data Network
49) LCS Location services
50) LEO Low Earth Orbit
51) MBSR Mobile Base Station Relay
52) MCC Mobile Country Code
53) MCS Mission Critical Service
54) ME Mobile Equipment
55) MEO Medium Earth Orbit
56) MICO Mobile Initiated Communication Only
57) D2D Device to Device
58) FQDN Fully Qualified Domain Name
59) PEGC PIN Element with Gateway Capability
60) PEMC PIN Element with Management Capability
61) PIN Personal IoT Network
62) PIN-E PIN Element
63) PINE PIN Element
64) PINAPP Personal IoT Network Application
65) MME Mobility Management Entity
66) MNC Mobile Network Code
67) MS Mobile Station. The present document makes no distinction between MS and UE.
68) NAS Non-Access Stratum
69) NG-RAN Next Generation Radio Access Network
70) NR New Radio
71) NTN Non Terrestrial Networks
72) NW Network
73) OOS Out of Service
74) PDN Packet Data Network
75) PDU Packet Data Unit
76) PLMN ID Public Land Mobile Network Identity
77) PSM Power Saving Mode
78) QoS Quality Of Service
79) RAT Radio Access Technology
80) RPLMN Registered Public Land Mobile Network
81) RRC Radio Resource Control
82) RU Registration Update
83) SAT Satellite
84) ProSe Proximity Services
85) Satellite an artificial body placed in orbit round the earth or moon or another planet in order to collect information or for communication.
86) Satellite Constellation Group of satellites, placed in orbit round the earth or moon or another planet in order to collect information or for communication.
87) SIM Subscriber Identity Module
88) SNPN Standalone Non-Public Networks
89) SUCI Subscription Concealed Identifier
90) SW Software
91) TAC Tracking Area Code
92) TAI Tracking Area Identity
93) TAU Tracking Area Update
94) TER Terrestrial
95) TN Terrestrial Networks
96) UCU UE Configuration Update
97) UDM Unified Data Management Function
98) UE User Equipment
99) UL Uplink
100) ULI User Location Information
101) UPU UE Parameters Update
102) USIM Universal Subscriber Identification Module
103) Uu The radio interface between the UE and the Node B
104) VPLMN Visited Public Land Mobile Network

### Visited Public Land Mobile Network (VPLMN): This is a Public Land Mobile

Network (PLMN) different from a HPLMN (if the EHPLMN list is not present or is empty) or different from an EHPLMN (if the EHPLMN list is present).

Allowable PLMN: In case of a Mobile Station (MS) operating in a MS operation mode A or B, this is the PLMN which is not in a list of “forbidden PLMNs” in the MS. In the case of the MS operating in a MS operation mode C or an MS not supporting A/Gb mode and not supporting Iu mode, this is the PLMN which is not in the list of “forbidden PLMNs” and not in the list of “forbidden PLMNs for General Packet Radio Service (GPRS)” in the MS.

Available PLMN: PLMN(s) in the given area which is/are broadcasting capability to provide wireless communication services to a User Equipment (UE).

Camped on a cell: The MS (ME if there is no SIM) has completed the cell selection/reselection process and has chosen a cell from which it plans to receive all available services. Note that the services may be limited, and that the PLMN or a Standalone Non-Public Networks (SNPN) may not be aware of existence of the MS (ME) within the chosen cell.

EHPLMN: Any of the PLMN entries contained in the Equivalent HPLMN list.

Equivalent HPLMN list: To allow provision for multiple HPLMN codes, PLMN codes that are present within this list shall replace the HPLMN code derived from the IMSI for PLMN selection purposes. This list is stored on a Universal Subscriber Identification Module (USIM) and is known as the EHPLMN list. The EHPLMN list may also contain the HPLMN code derived from the IMSI. If the HPLMN code derived from the IMSI is not present in the EHPLMN list then it shall be treated as a Visited PLMN for PLMN selection purposes.

Home PLMN: This is the PLMN where a Mobile Country Code (MCC) and a Mobile Network Code (MNC) of the PLMN identity match the MCC and MNC of the IMSI.

Registered PLMN (RPLMN): This is the PLMN on which certain LR (location registration which is also called as registration procedure) outcomes have occurred. In a shared network the RPLMN is the PLMN defined by the PLMN identity of the CN operator that has accepted the LR.

Registration: This is the process of camping on the cell of the PLMN or the SNPN and doing any necessary LRs.

UPLMN: PLMN/access technology combination in the “User Controlled PLMN Selector with Access Technology” data file in the SIM (in priority order);

OPLMN: PLMN/access technology combination in the “Operator Controlled PLMN Selector with Access Technology” data file in the SIM (in priority order) or stored in the ME (in priority order)

PIN (Personal IoT Network): Personal IoT Networks (PINs) provide local connectivity between UEs and/or non-3GPP devices. A Personal IoT Network (PIN) consists of PIN Elements (PINE) that communicate using PIN Direct Connection or direct network connection and is managed locally (using a PIN Element with Management Capability).

PINE (PIN Element): PIN Elements are UEs and/or non-3GPP devices which form part of the PIN.

PEMC (PIN Element with Management Capability): PIN Element which have the capability to provide means for an authorised administrator to configure and manage the PIN.

PEGC (PIN Element with Gateway Capability): PIN Elements with Gateway Capability provide means to PIN elements to register and access Fifth Generation (5G) network services. It can also help in communication between 2 PIN elements that are not within the range to use direct communication.

ProSe: ProSe (Proximity Services) is a D2D (Device-to-Device) technology that allows LTE devices to detect each other and to communicate directly.

PIN-ID: A unique identifier is associated with a PIN.

PINNF (PIN Network Function): The PIN Network function is a core network entity responsible for assignment and management of PIN-ID.

PINAF (PIN Application Function): The PIN Application function is a Network Function connected to 5G Core network via NEF (Network Exposure Function). The PINAF is responsible for policy configuration and provisioning of PIN and its elements.

Access Control Information: A set of information that assists the authorized PINE in a PIN to access 5GS network via PEGC, for example, the username or password.

A PIN enabler refers to overall functionality provided by the entities such as a PIN Client, a PIN Gateway Client, a PIN Management Client, and a PIN server in support of applications as per a PIN architecture. A PIN management refers to the set of operations related to creation, modification, maintenance and removal of PIN.

PIN Profile: A set of data and information about the PIN and PIN elements resides in the PIN.

Service Switch: A mechanism to switch a service traffic flow between an Application server (AS) and the PINE to the application server and other PINE.

Example list of NAS messages which is not limited to:
a) REGISTRATION REQUEST message;
b) DEREGISTRATION REQUEST message;
c) SERVICE REQUEST message;
d) CONTROL PLANE SERVICE REQUEST;
e) IDENTITY REQUEST;
f) AUTHENTICATION REQUEST;
g) AUTHENTICATION RESULT;
h) AUTHENTICATION REJECT;
i) REGISTRATION REJECT;
j) REGISTRATION ACCEPT;
k) DEREGISTRATION ACCEPT;
l) SERVICE REJECT;
m) SERVICE ACCEPT;
n) UE CONFIGURATION UPDATE command;
o) UE PARAMETERS UPDATE command;

The term 5GMM sublayer states in this embodiment is at least one of the below:
1) 5GMM-NULL
2) 5GMM-DEREGISTERED
a) 5GMM-DEREGISTERED.NORMAL-SERVICE
b) 5GMM-DEREGISTERED.LIMITED-SERVICE
c) 5GMM-DEREGISTERED.ATTEMPTING-REGISTRATION
d) 5GMM-DEREGISTERED.PLMN-SEARCH
e) 5GMM-DEREGISTERED.NO-SUPI
f) 5GMM-DEREGISTERED.NO-CELL-AVAILABLE
g) 5GMM-DEREGISTERED.eCALL-INACTIVE
h) 5GMM-DEREGISTERED.INITIAL-REGISTRATION-NEEDED
3) 5GMM-REGISTERED-INITIATED
4) 5GMM-REGISTERED
a) 5GMM-REGISTERED.NORMAL-SERVICE
b) 5GMM-REGISTERED.NON-ALLOWED-SERVICE
c) 5GMM-REGISTERED.ATTEMPTING-REGISTRATION-UPDATE
d) 5GMM-REGISTERED.LIMITED-SERVICE
e) 5GMM-REGISTERED.PLMN-SEARCH
f) 5GMM-REGISTERED.NO-CELL-AVAILABLE
g) 5GMM-REGISTERED.UPDATE-NEEDED
5) 5GMM-DEREGISTERED-INITIATED
6) 5GMM-SERVICE-REQUEST-INITIATED.

In this embodiment, the term EMM sublayer states are at least one of the below:
1) EMM-NULL
2) EMM-DEREGISTERED
a) EMM-DEREGISTERED.NORMAL-SERVICE
b) EMM-DEREGISTERED.LIMITED-SERVICE
c) EMM-DEREGISTERED.ATTEMPTING-TO-ATTACH
d) EMM-DEREGISTERED.PLMN-SEARCH
e) EMM-DEREGISTERED.NO-IMSI
f) EMM-DEREGISTERED.ATTACH-NEEDED
g) EMM-DEREGISTERED.NO-CELL-AVAILABLE
h) EMM-DEREGISTERED.eCALL-INACTIVE
3) EMM-REGISTERED-INITIATED
4) EMM-REGISTERED
a) EMM-REGISTERED.NORMAL-SERVICE
b) EMM-REGISTERED.ATTEMPTING-TO-UPDATE
c) EMM-REGISTERED.LIMITED-SERVICE
d) EMM-REGISTERED.PLMN-SEARCH
e) EMM-REGISTERED.UPDATE-NEEDED
f) EMM-REGISTERED.NO-CELL-AVAILABLE
g) EMM-REGISTERED.ATTEMPTING-TO-UPDATE-MM
h) EMM-REGISTERED.IMSI-DETACH-INITIATED
5) EMM-DEREGISTERED-INITIATED
6) EMM-TRACKING-AREA-UPDATING-INITIATED
7) EMM-SERVICE-REQUEST-INITIATED

The term RAT as defined in this embodiment is one of the following:—
(1) NG-RAN
(2) 5G, 4G, 3G, 2G
(3) EPS, 5GS
(4) NR
(5) NR in unlicensed bands
(6) NR (LEO) satellite access
(7) NR (MEO) satellite access
(8) NR (GEO) satellite access
(9) NR (OTHERSAT) satellite access
(10) NR RedCap
(11) E-UTRA
(12) E-UTRA in unlicensed bands
(13) NB-IoT
(14) WB-IoT
(15) LTE-M
5GS registration type are
(1) Initial registration
(2) Mobility registration updating
(3) Periodic registration updating
(4) Emergency registration
(5) SNPN onboarding registration
(6) Disaster roaming initial registration; or
(7) Disaster roaming mobility registration updating.

PLMN selection as per 23.122 without RPLMN: The MS selects and attempts registration on any PLMN/access technology combinations, if available and allowable, in the following order:
(1) Either the HPLMN (if the EHPLMN list is not present or is empty) or the highest priority EHPLMN that is available (if the EHPLMN list is present);
(2) Each PLMN/access technology combination in the “User Controlled PLMN Selector with Access Technology” data file in the SIM (in priority order);
(3) Each PLMN/access technology combination in the “Operator Controlled PLMN Selector with Access Technology” data file in the SIM (in priority order) or stored in the ME (in priority order);
(4) Other PLMN/access technology combinations with received high quality signal in random order;
(5) Other PLMN/access technology combinations in order of decreasing signal quality.

PLMN selection as per 23.122 with RPLMN: The MS selects and attempts registration on any PLMN/access technology combinations, if available and allowable, in the following order:
(1) Either the RPLMN or the Last registered PLMN;
(2) Either the HPLMN (if the EHPLMN list is not present or is empty) or the highest priority EHPLMN that is available (if the EHPLMN list is present);
(3) Each PLMN/access technology combination in the “User Controlled PLMN Selector with Access Technology” data file in the SIM (in priority order);
(4) Each PLMN/access technology combination in the “Operator Controlled PLMN Selector with Access Technology” data file in the SIM (in priority order) or stored in the ME (in priority order);
(5) Other PLMN/access technology combinations with received high quality signal in random order;
(6) Other PLMN/access technology combinations in order of decreasing signal quality.

Referring now to the drawings and more particularly to FIGS. 2 through 16, where similar reference characters denote corresponding features consistently throughout the figures, there are shown preferred embodiments.

FIG. 2 is a sequence diagram illustrating a 5GC and the PIN server (300) remove a PINE (100A) information from a context, according to the embodiments disclosed herein.

The PINE (100A)/PEGC (100B)/PEMC (100C) may de-register/lose connection/performs Periodic TAU/updates capabilities/de-authorizes with 5GC/5GS (200). When the PINE (100A)/PEGC (100B)/PEMC (100C) gets de-registered/loses connection from the 5GC/5GS (200), the PINE (100A)/PEGC (100B)/PEMC (100C) informs the PEGC (100B)/PIN server (300)/PEMC (100C) about de-registering/losing connection from the 5GC/5GS (200). In yet another embodiment, the 5GC/5GS (200) may inform the PIN server (300)/PEGC (100B)/PEMC (100C) or any PIN entity whenever the registration/authorization status (for example, 5GC registration/authorization status changes from Registered/Authorized to De-registered/Unauthorized or the PINE (100A)/PEGC (100B)/PEMC (100C) is deregistered from the 5GS/5GC) of the PINE (100A)/PEMC (100C)/PEGC (100B) changes. The PIN server (300)/Other PIN elements (such as PEGC (100B)/PEMC (100C) or PINE (100A)) may decide to either keep or remove the indicated or respective PINE (100A)/PEMC (100C)/PEGC (100B) in the PIN even though the PINE (100A)/PEGC (100B)/PEMC (100C) is deregistered/de-authorized from the 5GC/5GS (200). The PIN server (300) may trigger de-registration of PINE (100A)/PEGC (100B)/PEMC (100C) based on local data timers/subscription/periodic update/lifetime/authorization expiry etc.) Or based on PINE (100A) data/indication (indication received from PINE (100A)) or based on 5GC indication. If any of the PINE (100A) Profile Information or context or capabilities or PIN client profile information or PIN Profile Information changes due to change in 5GC/5GS (200) registration/authorization/capabilities status change of the PINE (100A)/PEGC (100B)/PEMC (100C), the PINE (100A) Profile Information or context or capabilities or PIN client profile information or PIN Profile Information is updated at PEGC (100B)/PEMC (100C) and/or PIN server (300).

The PINE (100A)/PEGC (100B)/PEMC (100C) which is part of multiple PINs may optionally have single registration with 5GC/5GS (200). If the PINE (100A)/PEMC (100C)/PEGC (100B) gets disconnected/de-registered/deleted/loses authorization/released from the PIN or PIN server (300) or if the complete PIN is deleted, the PINE (100A) Profile Information or context or capabilities or PIN client profile information or PIN Profile Information is updated at PEGC (100B)/PEMC (100C) and/or PIN server (300). The PIN server (300), in such a case, may not de-register the PINE (100A)/PEMC (100C)/PEGC (100B) as PINE (100A)/PEMC (100C)/PEGC (100B) may be a part of other PIN(s) registered with same PIN server (300). In yet another embodiment, the PIN server (300) may delete the PINE (100A)/PEGC (100B)/PEMC (100C) (UE) context/profile/information based on any event or trigger from the PINE (100A)/PEGC (100B)/PEMC (100C) or 5GC/5GS (200) (events such as, but not limited to, PINE (100A)/PEGC (100B)/PEMC (100C) Join/Delete/Leave/Register with/to the PIN or PIN server (300) or such as PIN create/delete etc.) if the PINE (100A)/PEGC (100B)/PEMC (100C) is not a part of any of the PIN anymore.

At step 1, the PINE/PEGC/PEMC is a part of a PIN, where the PINE/PEGC/PEMC is optionally, registered with 5GC/5GS and PIN Server. At step 2, the PINE/PEMC/PEGC de-registers with the 5GC. At step 3, 5GC/5GS 200 sends the PINE disconnection indication to the PIN server 300. At step 4, the 5GC and the PIN Server remove the PINE information from context.

FIG. 3 is a sequence diagram illustrating the 5GC and the PIN server (300) remove the PINE (100A) information from the context when a PINE context timer is expired, according to the embodiments disclosed herein.

At step 1, the PINE/PEGC/PEMC is a part of a PIN, where the PINE/PEGC/PEMC is optionally, registered with 5GC/5GS and PIN Server. At step 2, the PINE/PEMC/PEGC de-registers with the 5GC. Further, the PINE (100A)/PEGC (100B)/PEMC (100C) may perform periodic updates at PIN server (300) and/or 5GC/5GS (200) based on periodic timer assigned to it by PIN server (300)/5GC to indicate it is still part of PIN and maintain context at 5GC/5GS (200) and PIN server (300). The PINE (100A) maintains a timer, say ‘PIN server (300) periodic update timer’ or it may be any other name. PINE (100A) starts/resets this timer after every message/signal sent to PIN server (300). The PINE (100A) performs a periodic update procedure, in which it sends a periodic update message (it may be any other name) to the PIN server (300) on expiry of this timer. At step 2-At step 5, the PIN server (300) also maintains a Timer, say ‘PINE context timer’ or it may be any other name (whose value is just greater than the PIN server (300) periodic update timer maintained at PINE (100A)) to maintain the context for PINE (100A) at PIN server (300). If the PIN server (300) does not receive Periodic update from the PINE (100A) before the expiry of PINE Context timer for that PINE (100A), it deletes the PINE context from the PIN profile and updates the 5GC and/or PEGC (100B)/PEMC (100C) with same information. Say Periodic timer (PIN server (300) periodic update timer or 5GC periodic update timer) was of 30 minutes. PIN server (300)/PEMC (100C) can determine after 30 minutes that PINE (100A) is not available, or PIN sever/PEMC (100C) can start a new timer of duration “x” after which PIN server (300)/5GC determines PINE (100A) is not available.

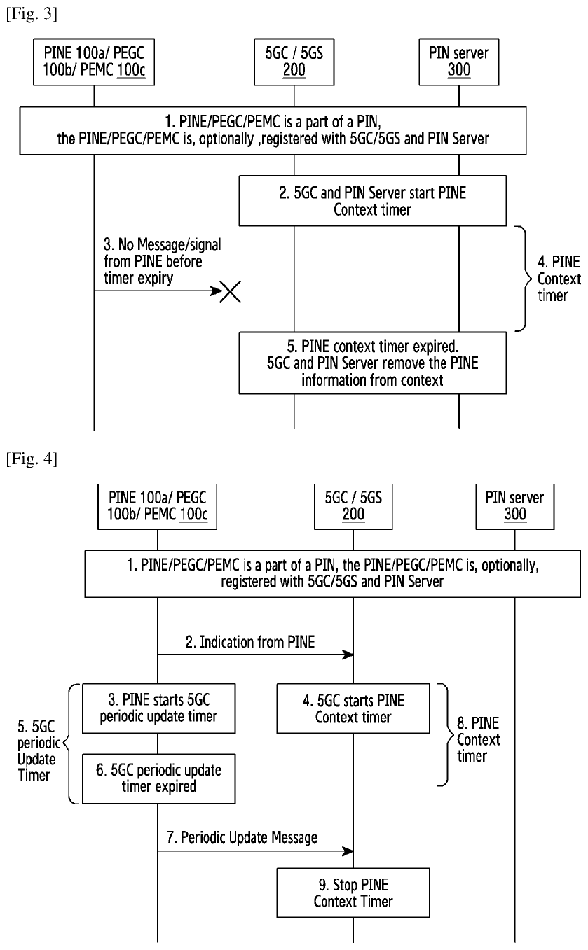

FIG. 4 is a sequence diagram illustrating the 5GC/5GS (200) are stop the PINE context timer when a 5GC periodic update timer is expired, according to the embodiments disclosed herein.

Similarly, The PINE (100A) maintains a timer, say ‘5GC periodic update timer’ or it may be any other name. PINE (100A) starts/resets this timer after every message/signal sent to the 5GC. The PINE (100A) performs the periodic update procedure, in which it sends a periodic update message (it may be any other name) to the 5GC on expiry of this timer. The 5GC also maintains a Timer, say ‘PINE context timer’ or it may be any other name (whose value is just greater than the 5GC periodic update timer maintained at PINE (100A)) to maintain the context for PINE (100A) at 5GC. If the 5GC does not receive Periodic update from the PINE (100A) before the expiry of PINE Context timer for that PINE (100A), it deletes the PINE context from the PIN profile and updates the PIN server (300) and/or PEGC (100B)/PEMC (100C) with same information.

FIG. 5 is a sequence diagram illustrating the PIN server (300) starts a PIN Element Context Periodic Update timer and periodically receive periodic updates from the 5GS/5GC about the PINE (100A)/PEGC (100B)/PEMC (100C), according to the embodiments disclosed herein.

The PIN server (300) can periodically update the 5GC with the PINE (100A)/PEGC (100B)/PEMC (100C) information indicating the PINE (100A)'s availability/current context/current registration/authorization/availability status. Similarly, the 5GC periodically updates the PIN server (300) with PINE (100A) information indicating the PINE (100A)'s availability/current context/current registration/authorization/availability status. Optionally, the PIN server (300) and/or 5GC/5GS (200) may start a timer, say a ‘PIN Element Context Periodic Update timer’ or it may be any other name. PIN server (300) and/or 5GC/5GS (200) starts/resets/re-starts/refreshes this timer after every message/signal sent to PIN server (300) or 5GS/5GC. The PIN server (300) and/or 5GC/5GS (200) performs the periodic update procedure, in which it sends a periodic update message (it may be any other name) to the PIN server (300) and/or 5GC/5GS (200) on expiry of this timer. The PIN server (300) and/or 5GC/5GS (200) also maintains a Timer, say a ‘PINE context delete wait timer’ or it may be any other name (whose value is just greater than the PIN Element Context Periodic Update timer maintained at PIN server (300) and/or 5GC/5GS (200)) to maintain the context for PINE (100A) at PIN server (300) and/or 5GC/5GS (200). If the PIN server (300) and/or 5GC/5GS (200) does not receive the periodic update from the PIN server (300) and/or 5GC/5GS (200) before the expiry of PINE Context delete wait timer for that PINE (100A), it deletes the PINE (100A)/PEGC (100B)/PEMC (100C) (UE) context/profile/information from the PIN or PIN Client profile and updates the PIN server (300) and/or 5GC/5GS (200) and/or PEGC (100B)/PEMC (100C) with same information.

The PIN server (300) or 5GC respectively deletes the PINE (100A)/PEGC (100B)/PEMC (100C) (UE) context/profile/information for the PINE (100A) if they do not receive the periodic update from the 5GC or the PIN server (300) respectively for the respective timer duration (for example, the ‘5GC periodic update timer’ or the ‘PIN server (300) periodic update timer’ or any other timer started between the 5GC/5GS (200) and the PIN server (300). Similarly, PIN server (300)/PEMC (100C) on determining by any of the methods explained earlier that PINE (100A) is deregistered/not available/unauthorized, PIN server (300)/PEMC (100C) triggers PINE (100A) removal from all the PINs the PINE (100A) is part of.

In the similar way, the PIN server (300) can start PIN Element Context Periodic Update timer and periodically receive periodic updates from the 5GS/5GC about the PINE (100A)/PEGC (100B)/PEMC (100C).

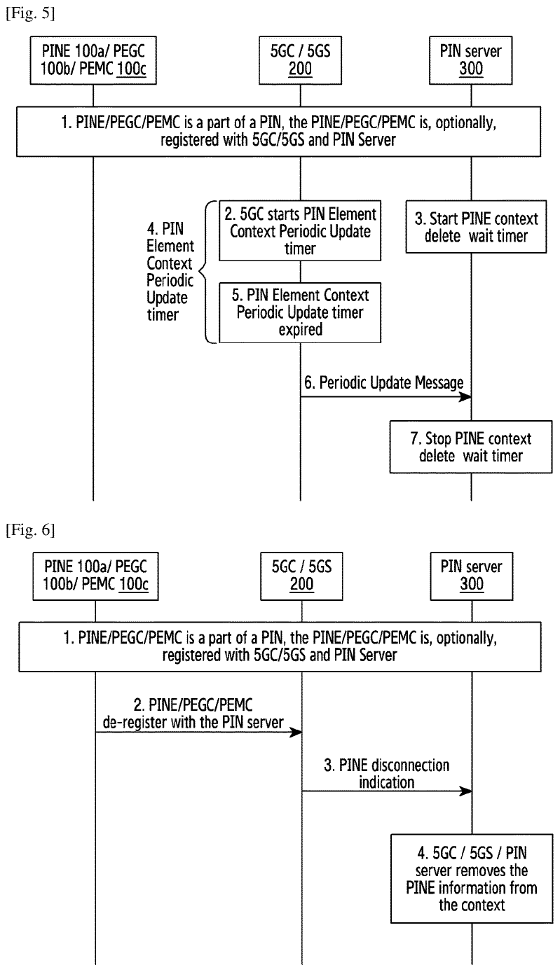

FIG. 6 is a sequence diagram illustrating the PINE (100A) sending de-registration request to the PIN server (300). The PIN server (300) then indicates to the 5GS/5GC (200) to remove the PINE (100A) information from the context, according to the embodiments disclosed herein.

The PINE (100A)/PEGC (100B)/PEMC (100C) may de-register/lose connection/performs Periodic update/updates capabilities/de-authorizes with PIN server (300). When the PINE (100A)/PEGC (100B)/PEMC (100C) gets de-registered/loses connection from the PIN server (300), the PINE (100A)/PEGC (100B)/PEMC (100C) informs the PEGC (100B)/PIN server (300)/PEMC (100C) about de-registering/losing connection from the PIN server (300). In yet another embodiment, the PIN server (300) may inform the PEGC (100B)/PEMC (100C)/5GC or any PIN entity whenever the registration/authorization status (for example, registration/authorization status changes from Registered/Authorized to De-registered/Unauthorized) of the PINE (100A)/PEMC (100C)/PEGC (100B) changes. The PIN server (300) may trigger de-registration of PINE (100A)/PEGC (100B)/PEMC (100C) based on local data timers/subscription/periodic update/lifetime/authorization expiry etc.) Based on PINE (100A) data/indication (indication received from PINE (100A)) or based on 5GC indication. If any of the 5GC/5GS (200) context for the PINE (100A) changes due to change in registration/authorization/capabilities status change of the PINE (100A)/PEGC (100B)/PEMC (100C) from PIN server (300), the PINE context is updated at the 5GC/5GS (200).

At step 1, the PINE 100a/the PEGC 100b/the PEMC 100c is a part of the PIN, where the PINE 100a/the PEGC 100b/the PEMC 100c is, optionally, registered with the 5GC/5GS (200) and the PIN server (300). At step 2, the PINE (100a)/PEGC (100b)/PEMC (100c) de-registers with the PIN server (300). At step 3, the PIN server (300) sends the PINE disconnection indication to the 5GC/5GS (200). At step 4, the 5GC/5GS (200)/PIN server (300) removes the PINE information from the context.

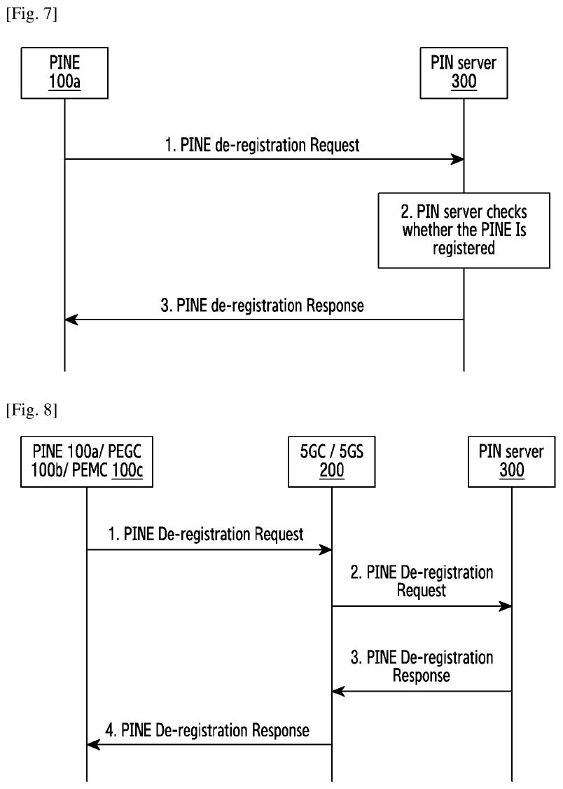

FIG. 7 is a sequence diagram illustration the PINE (100A) sending the PINE de-registration request to the PIN server (300) directly. At step 1, the PINE (100A) (including PINE (100A)/PEMC (100C)/PEGC (100B)) sends the PINE de-registration request to the PIN server (300). The PINE de-registration request includes the security credentials of the PINE (100A) received during authorization procedure and also the request may include the GPSI, MAC address, vendor name, device description, PIN element ID/PIN client ID, PIN ID, PINE Address. At step 2, the PIN server (300) checks whether the UE identified by the GPSI has active registration with the PIN server (300). At step 3, the PIN server (300) responds to the PINE (100A) with PINE de-registration response which contains the status of the PINE de-registration request. De-registration status indicates whether the PINE de-registration request was successful or not. Includes the cause of the failure if the de-registration fails. If the PINE (100A) is successfully de-registered, the PIN server (300) deletes all the configuration information it has related to the PIN element that is being de-registered. If the de-registration procedure fails, the PIN server (300) should give the failure response to indicates that indicates the cause of de-registration request failure.

FIG. 8 is a sequence diagram illustration the PINE (100A) sending a PINE de-registration request to PIN server (300) indirectly via the PEMC (100C) or the PEGC (100B). At step 1, the PINE (100A) (including PINE (100A)/PEMC (100C)/PEGC (100B)) sends the PINE de-registration Request to the PEMC (100C)/PEGC (100B). The request may include the security credentials of the PINE (100A) received during authorization procedure and also the request may include the GPSI, MAC address, vendor name, device description, PIN element ID/PIN client ID, PIN ID, PINE Address. At step 2, the PEMC (100C)/PEGC (100B) sends the PINE de-registration request to PIN server (300). The PIN server (300) checks whether the UE identified by the GPSI has active registration with the PIN server (300). At step 3, the PIN server (300) responds to the PEMC (100C)/PEGC (100B) with PINE de-registration response which contains the status of the PINE de-registration request. If the PINE (100A) is successfully de-registered, the PIN server (300) deletes all the configuration information it has related to the PIN element that is being de-registered. If the de-registration procedure fails, the PIN server (300) should give the failure response to indicates that indicates the cause of de-registration request failure. At step 4, the PEMC (100C)/PEGC (100B) sends the response received from PIN server (300) to the respective PIN, and updates the PIN Profile and PIN Client Profile accordingly.

Table 1 indicates the PINE de-registration request. Table 1 describes information elements in the PINE de-registration request from the PINE (including PEMC, PEGC, PINEs) to the PIN server.

TABLE 1

| Information element | Status | Description |
|---|---|---|
| UE Identifier | M | The identifier of the hosting UE (i.e. GPSI |
| | | or identity token) of PINE/PEMC/PEGC |
| Security credentials | M | Security credentials resulting from a |
| | | successful authorization for the PIN |
| | | service. |
| MAC address | O | MAC address of the requested PINEs. |
| Vendor name | O | The vendor's name of the PINE |
| Device description | O | Give the description of the device. |
| PINE Address | O | The IP address of PINE, if available. |

Table 2 indicates the PINE de-registration response. Table 2 describes information elements in the PINE de-registration response from the PIN server to the PINE (including PEMC, PEGC, PINEs).

TABLE 2

| Information element | Status | Description |
|---|---|---|
| De-registration status | M | Indicates whether the PINE de- |
| | | registration request was successful or not. |
| | | Includes the cause of the failure if the de- |
| | | registration fails. |

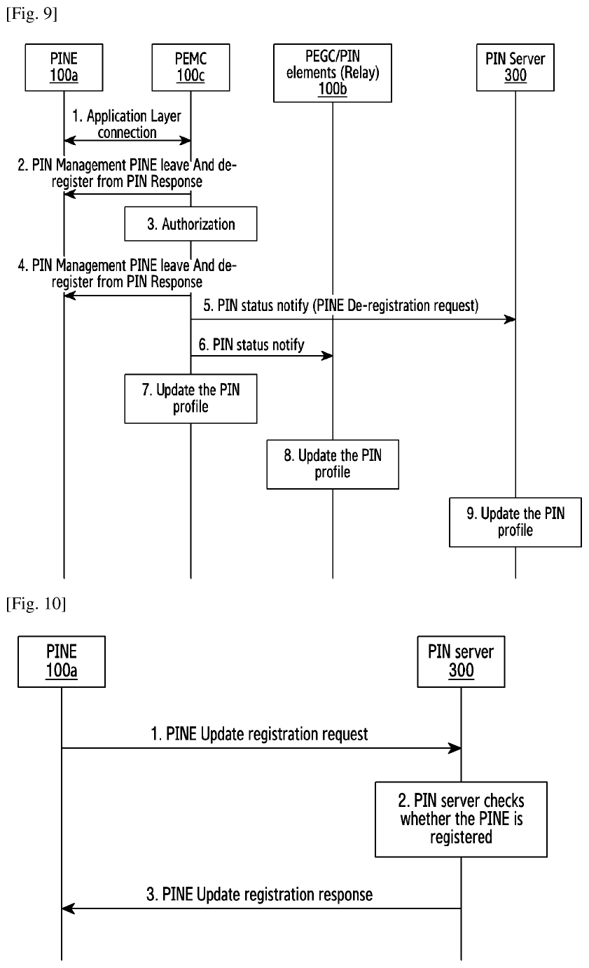

FIG. 9 is a sequence diagram illustration the PINE (100A) sending a PINE de-registration request to PIN server (300) indirectly via PEMC (100C) along with the PIN Leave Request (or it can be any PINE (100A) initiated procedure or request. At step 1 and step 2, the PINE (100A) (including PINE (100A)/PEMC (100C)/PEGC (100B)) sends a PINE leave and de-registration Request to the PEMC (100C)/PEGC (100B). The request may include the security credentials of the PINE (100A) received during authorization procedure and also the request may include the GPSI, MAC address, vendor name, device description, PIN element ID/PIN client ID, PIN ID, PINE Address. At step 3, the PEMC (100C) authorizes the request sent by PINE (100A) and decides to de-register/not de-register the PINE (100A). At step 4, the PEMC (100C)/PEGC (100B) after successful authorization sends the PINE (100A) deregistration response to the requesting PINE (100A). At step 5, the PEMC (100C)/PEGC (100B) sends the PIN status update (or any other message) including PINE de-registration request to PIN server (300), indicating that the PINE (100A) has de-registered. The PIN server (300) deletes all the configuration information it has related to the PIN element that is being de-registered. At step 6, the PEMC (100C) notifies all other PINE (100A)/PEGC (100B) about the PINE de-registration in the PIN Status notify message. At step 7-Step 9, the PEMC (100C)/PEGC (100B)/PINE (100A)/PIN server (300) update the PIN Profile and PIN Client Profile accordingly.

FIG. 10 is a sequence diagram illustration the PINE (100A) sending a PINE update registration request to PIN server (300) directly. At step 1, the PINE (100A) (including PINE (100A)/PEMC (100C)/PEGC (100B)) sends the PINE update registration request to the PIN server (300). The request includes the security credentials of the PINE (100A) received during authorization procedure and also the request may include the GPSI, MAC address, vendor name, device description, PIN element ID/PIN client ID, PINE Address. At step 2, the PIN server (300) checks whether the UE identified by the GPSI has active registration with the PIN server (300). At step 3, the PIN server (300) responds to the PINE (100A) with PINE update registration response which contains the status of the PINE update registration request. If the update registration procedure fails, the PIN server (300) should give the failure response to indicates that indicates the cause of update registration request failure.

In yet another embodiment, the PINE (100A) may send a PINE update registration request to PIN server (300) indirectly via PEGC (100B) or PEMC (100C). The PINE (100A) (including PINE (100A)/PEMC (100C)/PEGC (100B)) sends a PINE update registration request to the PEGC (100B)/PEMC (100C). The request includes the security credentials of the PINE (100A) received during authorization procedure and also the request may include the GPSI, MAC address, vendor name, device description, PIN element ID/PIN client ID, PINE Address. The PEGC (100B)/PEMC (100C) forwards the PINE update registration request to the PIN server (300). The PIN server (300) checks whether the UE identified by the GPSI has active registration with the PIN server (300). The PIN server (300) responds to the PEGC (100B)/PEMC (100C) with PINE update registration response which contains the status of the PINE update registration request. If the update registration procedure fails, the PIN server (300) should give the failure response to indicates that indicates the cause of update registration request failure. The PEMC (100C)/PEGC (100B) forwards the PINE update registration response to the PINE (100A).

Table 3 indicates the PINE update registration request. Table 3 describes information elements in the PINE update registration request from the PINE (including PEMC, PEGC, PINEs) to the PIN server.

TABLE 3

| Information element | Status | Description |
|---|---|---|
| UE Identifier | M | The identifier of the hosting UE (i.e. GPSI |
| | | or identity token) of PINE/PEMC/PEGC |
| Security credentials | M | Security credentials resulting from a |
| | | successful authorization for the PIN |
| | | service. |
| MAC address | O | MAC address of the requested PINEs. |
| Vendor name | O | The vendor's name of the PINE |
| Device description | O | Give the description of the device. |
| PINE Address | O | The IP address of PINE, if available. |

Table 4 describes the PINE update registration response. Table 4 describes information elements in the PINE de-registration response from the PIN server to the PINE (including PEMC, PEGC, PINEs).

TABLE 4

| Information element | Status | Description |
|---|---|---|
| Update registration status | M | Indicates whether the PINE |
| | | update registration request was |
| | | successful or not. |
| | | Includes the cause of the failure |
| | | if the update registration fails. |

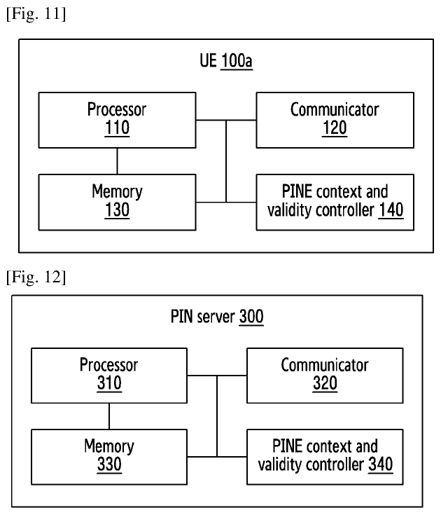

FIG. 11 shows various hardware components of the PINE (100A), according to the embodiments as disclosed herein. The PINE (100A) can be, for example, but not limited to the UE that communicates within the PIN, the non-3GPP device that communicates within the PIN, the PEMC (100C) and the PEGC (100B). In an embodiment, the PINE (100A) (100) includes a processor (110), a communicator (120), a memory (130) and a PINE context and validity controller (140). The processor (110) is coupled with the communicator (120), the memory (130) and the PINE context and validity controller (140).

The PINE context and validity controller (140) sends the PINE de-registration request to the PIN server (300). The PINE de-registration request includes the security credential and information. The information comprises at least one of: the GPSI, the MAC address, the vendor's name, the device description, the PINE element ID, the PIN client ID and the PINE address. In an embodiment, the PINE context and validity controller (140) sends the PINE de-registration request to the PIN server (300) directly or via at least one of: the PEMC (100C) and the PEGC (100B).

Further, the PINE context and validity controller (140) receives the PINE de-registration response with a status of the PINE de-registration request from the PIN server (300) directly or via at least one of: the PEMC (100C) and the PEGC (100B) based on the PINE de-registration request. The PINE de-registration response indicates at least one of: the PIN server (300) deletes all configuration for the PINE (100A) when the PINE (100A) is successfully de-registered, and the PIN server (300) gives failure response with cause of de-registration failure to the PINE (100A), when the PINE (100A) is not successfully de-registered.

In another embodiment, the PINE context and validity controller (140) sends the PINE update registration request to the PIN server (300). The PINE update registration request includes the security credential and the information. The PINE context and validity controller (140) receives the PINE update registration response with the status of the PINE update registration request from the PIN server (300) based on the PINE update registration request. The PIN server (300) provides the failure response with cause of update registration failure to the PINE (100A), when the PINE update registration request is failed.

The PINE context and validity controller (140) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (110) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (110) may include multiple cores and is configured to execute the instructions stored in the memory (130).

Further, the processor (110) is configured to execute instructions stored in the memory (130) and to perform various processes. The communicator (120) is configured for communicating internally between internal hardware components and with external devices via one or more networks. The memory (130) also stores instructions to be executed by the processor (110). The memory (130) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (130) may, in some examples, be considered a non-transitory storage medium. The term “non-transitory”may indicate that the storage medium is not embodied in a carrier wave or a propagated signal. However, the term “non-transitory” should not be interpreted that the memory (130) is non-movable. In certain examples, a non-transitory storage medium may store data that can, over time, change (e.g., in Random Access Memory (RAM) or cache).

In an embodiment, the communicator (120) includes an electronic circuit specific to a standard that enables wired or wireless communication. The communicator (120) is configured to communicate internally between internal hardware components of the UE and with external devices via one or more networks.

Although the FIG. 11 shows various hardware components of the PINE (100A) but it is to be understood that other embodiments are not limited thereon. In other embodiments, the PINE (100A) may include less or more number of components. Further, the labels or names of the components are used only for illustrative purpose and does not limit the scope of the invention. One or more components can be combined together to perform same or substantially similar function in the PINE (100A).

The solutions discussed in this embodiment is being illustrated by showing request (for e.g. de-registration request or update registration request) being triggered by PINE directly or indirectly via PEGC or PEMC to the PIN server as an example. However, the solution is not restricted to this combination only. The request (for e.g. de-registration request or update registration request) can be initiated or exchanged between any set of entities in any order or combinations. The entities include but not restricted to PINE, PEGC, PEMC, PIN Server, 5GC/5GC or any Network or Server Entity either directly or indirectly via any other entity.

FIG. 12 shows various hardware components of the PIN server (300), according to the embodiments as disclosed herein. In an embodiment, the PIN server (300) includes a processor (310), a communicator (320), a memory (330) and a PINE context and validity controller (340). The processor (310) is coupled with the communicator (320), the memory (330) and the PINE context and validity controller (340).

The PINE context and validity controller (340) receives the PINE de-registration request from at least one of the PINE (100A), the PEMC (100C) and the PEGC (100B). The PINE de-registration request includes the security credential and the information. The PINE context and validity controller (340) validates the PINE (100A) based on the PINE de-registration request. Further, the PINE context and validity controller (340) determines that the PINE (100A) has the active registration with the PIN server (300). Further, the PINE context and validity controller (340) sends the PINE de-registration response with the status of the PINE de-registration request to the PINE (100A) based on the determination. The PINE de-registration response indicates at least one of: the PIN server (300) deletes all configuration for the PINE (100A), when the PINE (100A) is successfully de-registered, and the PIN server (300) gives failure response with cause of de-registration failure to the PINE (100A), when the PINE (100A) is not successfully de-registered.

In another embodiment, the PINE context and validity controller (340) receives the PINE update registration request from the PINE (100A). The PINE update registration request includes the security credential and the information. The PINE context and validity controller (340) validates the PINE (100A) based on the PINE update registration request. The PINE context and validity controller (340) determines that the PINE (100A) has the active registration with the PIN server (300). The PINE context and validity controller (340) sends the PINE update registration response with the status of the PINE update registration request to the PINE (100A) based on the determination.

The PINE context and validity controller (340) is implemented by analog and/or digital circuits such as logic gates, integrated circuits, microprocessors, microcontrollers, memory circuits, passive electronic components, active electronic components, optical components, hardwired circuits and the like, and may optionally be driven by firmware.

The processor (310) may include one or a plurality of processors. The one or the plurality of processors may be a general-purpose processor, such as a central processing unit (CPU), an application processor (AP), or the like, a graphics-only processing unit such as a graphics processing unit (GPU), a visual processing unit (VPU), and/or an AI-dedicated processor such as a neural processing unit (NPU). The processor (310) may include multiple cores and is configured to execute the instructions stored in the memory (330).

Further, the processor (310) is configured to execute instructions stored in the memory (330) and to perform various processes. The communicator (320) is configured for communicating internally between internal hardware components and with external devices via one or more networks. The memory (330) also stores instructions to be executed by the processor (310). The memory (330) may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory (330) may, in some examples, be considered a non-transitory storage medium. The term “non-transitory” may indicate that the storage medium is not embodied in a carrier wave or a propagated signal. However, the term “non-transitory” should not be interpreted that the memory (330) is non-movable. In certain examples, a non-transitory storage medium may store data that can, over time, change (e.g., in Random Access Memory (RAM) or cache).

In an embodiment, the communicator (320) includes an electronic circuit specific to a standard that enables wired or wireless communication. The communicator (330) is configured to communicate internally between internal hardware components of the UE and with external devices via one or more networks.

Although the FIG. 12 shows various hardware components of the PIN server (300) but it is to be understood that other embodiments are not limited thereon. In other embodiments, the PIN server (300) may include less or more number of components. Further, the labels or names of the components are used only for illustrative purpose and does not limit the scope of the invention. One or more components can be combined together to perform same or substantially similar function in the PIN server (300).

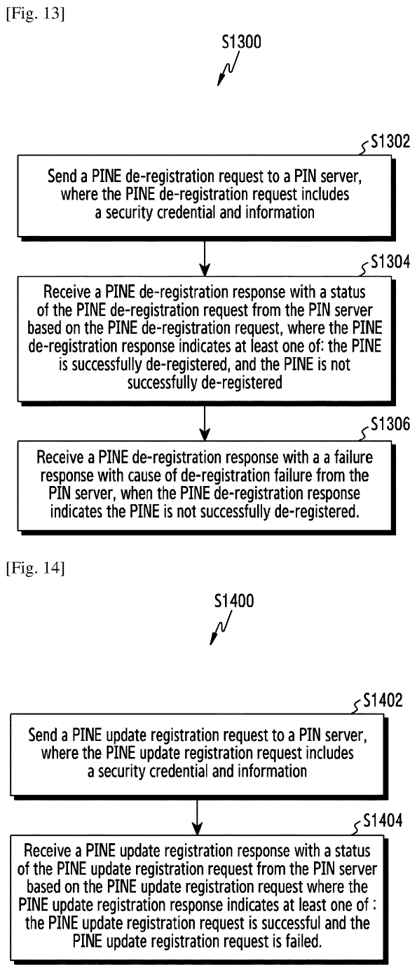

FIG. 13 is a flow chart (S1300) illustrating method, implemented by the PINE (100A), for handling PINE context and validity of the PIN element based on the PINE de-registration request, according to the embodiments as disclosed herein. The operations (S1302 and S1304) are handled by the PINE context and validity controller (140).

At S1302, the method includes sending the PINE de-registration request to the PIN server (300). The PINE de-registration request includes the security credential and information. At S1304, the method includes receiving the PINE de-registration response with the status of the PINE de-registration request from the PIN server (300) based on the PINE de-registration request. The PINE de-registration response indicates at least one of: the PINE (100A) is successfully de-registered, and t the PINE (100A) is not successfully de-registered. At S1306, the method includes receive a PINE de-registration response with a failure response with cause of de-registration failure from the PIN server, when the PINE de-registration response indicates the PINE is not successfully de-registered

FIG. 14 is a flow chart (S1400) illustrating method, implemented by the PINE (100A), for handling PINE context and validity of the PIN element based on the PINE update registration request, according to the embodiments as disclosed herein. The operations (S1402 and S1404) are handled by the PINE context and validity controller (140).

At S1402, the method includes sending the PINE update registration request to the PIN server (300). The PINE update registration request includes the security credential and information. At S1404, the method includes receiving the PINE update registration response with the status of the PINE update registration request from the PIN server (300) based on the PINE update registration request where the PINE update registration response indicates at least one of: the PINE update registration request is successful and the PINE update registration request is failed.

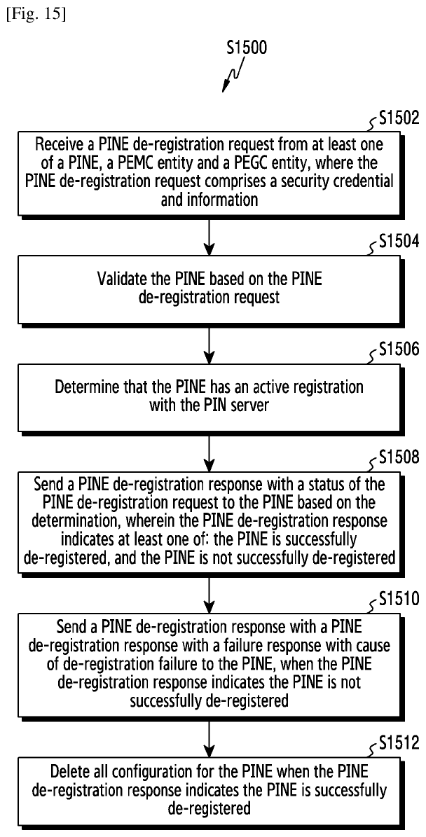

FIG. 15 is a flow chart (S1500) illustrating method, implemented by the PIN server (300), for handling PINE context and validity of the PIN element based on the PINE de-registration request, according to the embodiments as disclosed herein. The operations (S1502-S1512) are handled by the PINE context and validity controller (340). At S1502, the method includes receiving the PINE de-registration request from at least one of the PINE (100A), the PEMC (100C) and the PEGC (100B). The PINE de-registration request includes the security credential and information. At S1504, the method includes validating the PINE (100A) based on the PINE de-registration request. At S1506, the method includes determining that the PINE (100A) has the active registration with the PIN server (300). At S1508, the method includes sending the PINE de-registration response with a status of the PINE de-registration request to the PINE (100A) based on the determination. The PINE de-registration response indicates at least one of: the PINE (100A) is successfully de-registered, and the PINE (100A) is not successfully de-registered. At S1510, the method includes sending a PINE de-registration response with a PINE de-registration response with a failure response with cause of de-registration failure to the PINE, when the PINE de-registration response indicates the PINE is not successfully de-registered. At, S1512, the method includes deleting all configuration for the PINE when the PINE de-registration response indicates the PINE is successfully de-registered.

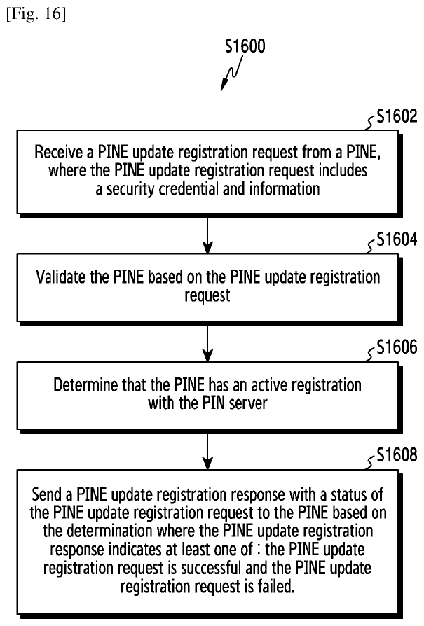

FIG. 16 is a flow chart (S1600) illustrating method, implemented by the PIN server (300), for handling PINE context and validity of the PIN element based on the PINE update registration request, according to the embodiments as disclosed herein. The operations (S1602-S1608) are handled by the PINE context and validity controller (340).

At S1602, the method includes receiving the PINE update registration request from the PINE (100A). The PINE update registration request includes the security credential and the information. At S1604, the method includes validating the PINE (100A) based on the PINE update registration request. At S1606, the method includes determining that the PINE (100A) has the active registration with the PIN server (300). At S1608, the method includes sending the PINE update registration response with a status of the PINE update registration request to the PINE (100A) based on the determination. The PINE update registration response indicates at least one of: the PINE update registration request is successful and the PINE update registration request is failed.

In an embodiment of this disclosure, a method for handling Personal IoT Network (PIN) element (PINE) context and validity of a PIN element, comprising: sending, by a PINE (100A), a PINE de-registration request to a PIN server (300), wherein the PINE de-registration request comprises a security credential and information; receiving, by the PINE (100A), a PINE de-registration response with a status of the PINE de-registration request from the PIN server (300) based on the PINE de-registration request, wherein the PINE de-registration response indicates at least one of: the PINE (100A) is successfully de-registered, and the PINE (100A) is not successfully de-registered; and receiving, by the PINE (100A), a PINE de-registration response with a failure response with cause of de-registration failure from the PIN server (300), when the PINE de-registration response indicates the PINE (100A) is not successfully de-registered.

In an embodiment of this disclosure, wherein the PINE (100A) sends the PINE de-registration request to the PIN server (300) directly or via at least one of: a PIN Element with Management Capability (PEMC) (100C) and a PIN Element with Gateway Capability (PEGC) (100B).

In an embodiment of this disclosure, wherein the PINE (100A) receives the PINE de-registration response with the status of the PINE de-registration request from the PIN server (300) directly or via at least one of: a PEMC (100C) and a PEGC (100B).

In an embodiment of this disclosure, wherein the PINE (100A) comprises at least one of: a User Equipment (UE) that communicates within a PIN, a non-3GPP device that communicates within a PIN, a PEMC (100C) and a PEGC (100B), and wherein the information comprises at least one of: a Generic Public Subscription Identifier (GPSI), a Medium Access Control (MAC) address, vendor name, a device description, a PIN element identifier (ID), a PIN client ID and a PINE address.

In an embodiment of this disclosure, a method for handling Personal IoT Network (PIN) element (PINE) context and validity of a PIN element, comprising: receiving, by a PIN server (300), a PINE de-registration request from at least one of a PINE (100A), a PEMC (100C) and a PEGC (100B), wherein the PINE de-registration request comprises a security credential and information; validating, by the PIN server (300), the PINE (100A) based on the PINE de-registration request; determining, by the PIN server (300), that the PINE (100A) has an active registration with the PIN server (300); sending, by the PIN server (300), a PINE de-registration response with a status of the PINE de-registration request to the PINE (100A) based on the determination, wherein the PINE de-registration response indicates at least one of: the PINE (100A) is successfully de-registered, and the PINE (100A) is not successfully de-registered; sending, by the PIN server (300), a PINE de-registration response with a failure response with cause of de-registration failure to the PINE (100A), when the PINE de-registration response indicates the PINE (100A) is not successfully de-registered; and deleting, by the PIN server (300), all configuration for the PINE (100A), when the PINE de-registration response indicates the PINE (100A) is successfully de-registered.

In an embodiment of this disclosure, wherein the PIN server (300) receives the PINE de-registration request from the PINE (100A) directly or via at least one of: a PIN Element with Management Capability (PEMC) (100C) and a PIN Element with Gateway Capability (PEGC) (100B).

In an embodiment of this disclosure, wherein the PIN server (300) sends the PINE de-registration response with the status of the PINE de-registration request to the PINE (100A) directly or via at least one of: a PEMC (100C) and a PEGC (100B).

In an embodiment of this disclosure, wherein the PINE (100A) comprises at least one of: a UE that communicates within a PIN, a non-3GPP device that communicates within a PIN, a PEMC (100C) and a PEGC (100B), and wherein the information comprises at least one of: a GPSI, MAC Address, vendor Name, Device Description, PIN Element ID, PIN Client ID and a PINE address.

In an embodiment of this disclosure, a method for handling Personal IoT Network (PIN) element (PINE) context and validity of the PIN element, comprising: sending, by a PINE (100A), a PINE update registration request to a PIN server (300), wherein the PINE update registration request comprises a security credential and information; and receiving, by the PINE (100A), a PINE update registration response with a status of the PINE update registration request from the PIN server (300) based on the PINE update registration request, wherein the PINE update registration response indicates at least one of: the PINE (100A) update registration request is successful and the PINE (100A) update registration request is failed.

In an embodiment of this disclosure, wherein PIN server (300) provides a failure response with cause of update registration failure to the PINE (100A), when the PINE update registration request is failed.

In an embodiment of this disclosure, wherein the PINE (100A) sends the PINE update registration request to the PIN server (300) directly or via at least one of: a PIN Element with Management Capability (PEMC) (100C) and PIN Element with Gateway Capability (PEGC) (100B).

In an embodiment of this disclosure, wherein the PINE (100A) receives the PINE update registration response with the status of the PINE update registration request from the PIN server (300) directly or via at least one of: a PEMC (100C) and a PEGC (100B).

In an embodiment of this disclosure, wherein the PINE (100A) comprises at least one of: a UE that communicates within a PIN, a non-3GPP device that communicates within a PIN, a PEMC (100C) and a PEGC (100B), and wherein the information comprises at least one of: a GPSI, MAC Address, vendor Name, Device Description, PIN Element ID, PIN Client ID and a PINE address.

In an embodiment of this disclosure, a method for handling Personal IoT Network (PIN) element (PINE) context and validity of the PIN element, comprising: receiving, by a PIN server (300), a PINE update registration request from a PINE (100A), wherein the PINE update registration request comprises a security credential and information; validating, by the PIN server (300), the PINE (100A) based on the PINE update registration request; determining, by the PIN server (300), that the PINE (100A) has an active registration with the PIN server (300); and sending, by the PIN server (300), a PINE update registration response with a status of the PINE update registration request to the PINE (100A) based on the determination, wherein the PINE update registration response indicates at least one of: the PINE (100A) update registration request is successful and the PINE (100A) update registration request is failed.

In an embodiment of this disclosure, wherein the PIN server (300) provides a failure response with cause of update registration failure to the PINE (100A), when the PINE update registration request is failed.

In an embodiment of this disclosure, wherein the PIN server (300) receives the PINE update registration request from the PINE (100A) directly or via at least one of: a PIN Element with Management Capability (PEMC) (100C) and a PIN Element with Gateway Capability (PEGC) (100B).

In an embodiment of this disclosure, wherein the PIN server (300) sends the PINE update registration response with the status of the PINE update registration request to the PINE (100A) directly or via at least one of: a PEMC (100C) and a PEGC (100B).

In an embodiment of this disclosure, wherein the PINE (100A) comprises at least one of: a UE that communicates within a PIN, a non-3GPP device that communicates within a PIN, a PEMC (100C) and a PEGC (100B), and wherein the information comprises at least one of: a GPSI, MAC Address, vendor Name, Device Description, PIN Element ID, PIN Client ID and a PINE address.

In an embodiment of this disclosure, a PINE (100A) for handling a PINE context and validity of the PIN element, comprising: a memory (130); a processor (110); and a PINE context and validity controller (140), communicatively coupled to the memory (130) and the processor (110), configured to: send a PINE de-registration request to a PIN server (300), wherein the PINE de-registration request comprises a security credential and information; receive a PINE de-registration response with a status of the PINE de-registration request from the PIN server (300) based on the PINE de-registration request, wherein the PINE de-registration response indicates at least one of: the PINE (100A) is successfully de-registered, and the PINE (100A) is not successfully de-registered; and receive a PINE de-registration response with a failure response with cause of de-registration failure from the PIN server (300), when the PINE de-registration response indicates the PINE (100A) is not successfully de-registered.

In an embodiment of this disclosure, a PINE (100A) for handling a PINE context and validity of the PIN element, comprising: a memory (130); a processor (110); and a PINE context and validity controller (140), communicatively coupled to the memory (130) and the processor (110), configured to: send a PINE update registration request to a PIN server (300), wherein the PINE update registration request comprises a security credential and information; and receive a PINE update registration response with a status of the PINE update registration request from the PIN server (300) based on the PINE update registration request, wherein the PINE update registration response indicates at least one of: the PINE (100A) update registration request is successful and the PINE (100A) update registration request is failed.

In an embodiment of this disclosure, a PIN server (300) for handling PINE context and validity of the PIN element, comprising: a memory (330); a processor (310); and a PINE context and validity controller (340), communicatively coupled to the memory (330) and the processor (310), configured to: receive a PINE de-registration request from at least one of a PINE (100A), a PEMC (100C) and a PEGC (100B), wherein the PINE de-registration request comprises a security credential and information; validate the PINE (100A) based on the PINE de-registration request; determine that the PINE (100A) has an active registration with the PIN server (300); send a PINE de-registration response with a status of the PINE de-registration request to the PINE (100A) based on the determination, wherein the PINE de-registration response indicates at least one of: t the PINE (100A) is successfully de-registered, and the PINE (100A) is not successfully de-registered; send a PINE de-registration response with a failure response with cause of de-registration failure to the PINE (100A), when the PINE de-registration response indicates the PINE (100A) is not successfully de-registered; and delete all configuration for the PINE (100A), when the PINE de-registration response indicates the PINE (100A) is successfully de-registered.

In an embodiment of this disclosure, a PIN server (300) for handling PINE context and validity of the PIN element, comprising: a memory (330); a processor (310); and a PINE context and validity controller (340), communicatively coupled to the memory (330) and the processor (310), configured to: receive a PINE update registration request from a PINE (100A), wherein the PINE update registration request comprises a security credential and information; validate the PINE (100A) based on the PINE update registration request; determine that the PINE (100A) has an active registration with the PIN server (300); and send a PINE update registration response with a status of the PINE update registration request to the PINE (100A) based on the determination, wherein the PINE update registration response indicates at least one of: the PINE (100A) update registration request is successful and the PINE (100A) update registration request is failed.

The various actions, acts, blocks, steps, or the like in the flow charts (S1300 to S1600) may be performed in the order presented, in a different order or simultaneously. Further, in some embodiments, some of the actions, acts, blocks, steps, or the like may be omitted, added, modified, skipped, or the like without departing from the scope of the invention.

The foregoing description of the specific embodiments will so fully reveal the general nature of the embodiments herein that others can, by applying current knowledge, readily modify or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

1-15. (canceled)

16. A method performed by a personal internet of things (IoT) network element (PINE) in a wireless communication system, the method comprising:
transmitting, to a personal IoT network (PIN) server, a request for de-registration, the request for the de-registration including a security credential of the PINE received during an authorization procedure with the PIN server; and
receiving, from the PIN server, a response for the de-registration, the response including a status of the request for the de-registration.

17. The method of claim 16, wherein the request for the de-registration further includes at least one of a generic public subscription identifier (GPSI), a medium access control (MAC) address, a vendor name, a device description, a PINE identifier (ID), a PIN client ID, or a PINE address.

18. The method of claim 16, wherein, in case that the de-registration fails, the response for the de-registration includes a cause of a failure of the request for the de-registration,
wherein the request for the de-registration is transmitted directly to the PIN server or indirectly via a PINE with management capability (PEMC) to the PIN server, and
wherein the response for the de-registration is received directly from the PIN server or indirectly via the PEMC from the PIN server.

19. The method of claim 16, further comprising:
transmitting, to the PIN server, a request for an update of a registration to the PIN server, the request for the update including the security credential of the PINE; and
receiving, from the PIN server, a response for the update of the registration, the response for the update including a status of the request for the update,
wherein, in case that the update fails, the response for the update includes a cause of a failure of the request for the update.

20. The method of claim 19, wherein the request for the update of the registration is transmitted directly to the PIN server or indirectly via a PINE with gateway capability (PEGC) to the PIN server, and
wherein the response for the update of the registration is received directly from the PIN server or indirectly via the PEGC from the PIN server.

21. A method performed by a personal internet of things (IoT) network (PIN) server in a wireless communication system, the method comprising:
receiving, from a PIN element (PINE), a request for de-registration, the request for the de-registration including a security credential of the PINE received during an authorization procedure with the PIN server; and
transmitting, to the PINE, a response for the de-registration, the response for the de-registration including a status of the request for the de-registration.

22. The method of claim 21, wherein the request for the de-registration further includes at least one of a generic public subscription identifier (GPSI), a medium access control (MAC) address, a vendor name, a device description, a PINE identifier (ID), a PIN client ID, or a PINE address.

23. The method of claim 21, wherein, in case that the de-registration fails, the response for the de-registration includes a cause of a failure of the request for the de-registration,
wherein the request for the de-registration is received directly from the PINE or indirectly via a PIN element with management capability (PEMC) from the PINE, and
wherein the response for the de-registration is transmitted directly to the PINE or indirectly via the PEMC to the PINE.

24. The method of claim 21, further comprising:
receiving, from the PINE, a request for an update of a registration to the PIN server, the request for the update including the security credential of the PINE; and
transmitting, to the PINE, a response for the update of the registration, the response for the update including a status of the request for the update,
wherein, in case that the update fails, the response for the update includes a cause of a failure of the request for the update.

25. The method of claim 24,
wherein the request for the update of the registration is received directly from the PINE or indirectly via a PINE with gateway capability (PEGC) from the PINE,
wherein the response for the update of the registration is transmitted directly to the PINE or indirectly via the PEGC to the PINE.

26. A personal internet of things (IoT) network element (PINE) in a wireless communication system, the PINE comprising:
a transceiver; and
a controller coupled with the transceiver and configured to:
transmit, to a personal IoT network (PIN) server, a request for de-registration, the request including a security credential of the PINE received during an authorization procedure with the PIN server, and
receive, from the PIN server, a response for the de-registration, the response for the de-registration including a status of the request for the de-registration.

27. The PINE of claim 26, wherein the request for the de-registration further includes at least one of a generic public subscription identifier (GPSI), a medium access control (MAC) address, a vendor name, a device description, a PINE identifier (ID), a PIN client ID, or a PINE address.

28. The PINE of claim 26, wherein, in case that the de-registration fails, the response for the de-registration includes a cause of a failure of the request for the de-registration,
wherein the request for the de-registration is transmitted directly to the PIN server or indirectly via a PINE with management capability (PEMC) to the PIN server, and
wherein the response for the de-registration is received directly from the PIN server or indirectly via the PEMC from the PIN server.

29. The PINE of claim 26, wherein the controller is further configured to:
transmit, to the PIN server, a request for an update of a registration to the PIN server, the request for the update including the security credential of the PINE, and
receive, from the PIN server, a response for the update of the registration, the response for the update including a status of the request for the update,
wherein, in case that the update fails, the response for the update includes a cause of a failure of the request for the update.

30. The PINE of claim 29, wherein the request for the update of the registration is transmitted directly to the PIN server or indirectly via a PINE with gateway capability (PEGC) to the PIN server, and
wherein the response for the update of the registration is received directly from the PIN server or indirectly via the PEGC from the PIN server.

31. A personal internet of things (IoT) network (PIN) server in a wireless communication system, the PIN server comprising:
a transceiver; and
a controller coupled with the transceiver and configured to:
receive, from a PIN element (PINE), a request for de-registration, the request for the de-registration including a security credential of the PINE received during an authorization procedure with the PIN server, and
transmit, to the PINE, a response for the de-registration, the response for the de-registration including a status of the request for the de-registration.

32. The PIN server of claim 31, wherein the request for the de-registration further includes at least one of a generic public subscription identifier (GPSI), a medium access control (MAC) address, a vendor name, a device description, a PINE identifier (ID), a PIN client ID, or a PINE address.

33. The PIN server of claim 31, wherein, in case that the de-registration fails, the response for the de-registration includes a cause of a failure of the request for the de-registration,
wherein the request for the de-registration is received directly from the PINE or indirectly via a PINE with management capability (PEMC) from the PINE, and
wherein the response for the de-registration is transmitted directly to the PINE or indirectly via the PEMC to the PINE.

34. The PIN server of claim 31, wherein the controller is further configured to:
receive, from the PINE, a request for an update of a registration to the PIN server, the request for the update including the security credential of the PINE, and
transmit, to the PINE, a response for the update of the registration, the response for the update including a status of the request for the update,
wherein, in case that the update fails, the response for the update includes a cause of a failure of the request for the update.

35. The PIN server of claim 34, wherein the request for the update of the registration is received directly from the PINE or indirectly via a PINE with gateway capability (PEGC) from the PINE, and
wherein the response for the update of the registration is transmitted directly to the PINE or indirectly via the PEGC to the PINE.
